(19) United States
(12) Patent Application Publication
(10) Pub. No.: US 2025/0102711 A1
(43) Pub. Date: Mar. 27, 2025

(54) A LIDAR MULTIFACETED ROTATING PRISM

(71) Applicant: INNOVUSION (SUZHOU) CO., LTD., SUZHOU (CN)

(72) Inventors: Shuai Zhao, SUZHOU (CN); Lirui Lu, SUZHOU (CN); Yufeng Li, SUZHOU (CN); Gonghao Guan, SUZHOU (CN)

(73) Assignee: INNOVUSION (SUZHOU) CO., LTD., SUZHOU, JS (CN)

(21) Appl. No.: 18/722,547

(22) PCT Filed: Dec. 20, 2022
(86) PCT No.: PCT/IB2022/062513

§ 371 Date: Jun. 20, 2024

(30) Foreign Application Priority Data
Dec. 21, 2021 (CN) 202111569011.8

(51) Int. Cl. G02B 5/04; G02B 1/04; G02B 7/18

(52) U.S. Cl. CPC G02B 5/04; G02B 1/04; G02B 7/1805

(57) ABSTRACT

The present invention discloses a LiDAR multifaceted rotating prism comprising an inner core (1); a cladding layer (2) connected to the outer surface of the inner core, wherein the cladding layer is a polygonal prism rotationally symmetric about the central axis of the inner core; and an optical film (3) coated on the outer surface of the cladding layer.

### CROSS-REFERENCE TO RELATED APPLICATIONS

This application claims priority to Chinese Patent Application No. 202111569011.8, filed Dec. 21, 2021, entitled “A POLYHEDRAL ROTATING PRISM FOR LIDAR,” the content of which is hereby incorporated by reference in its entirety.

### TECHNICAL FIELD

The present invention relates to the field of vehicle-mounted LiDAR, and in particular to a LiDAR multifaceted rotating prism.

### BACKGROUND

At present, the rotating prism of the vehicle-mounted LiDAR is generally processed from a single material such as plastic, metal or glass, etc. Since the surface shape and thermal deformation of plastic materials are difficult to control during rotation, the metal and glass solutions would have serious cost problems.

A LiDAR device in the reference with the publication number CN201820249024.4 has the following problems.

Since the rotating prism usually involves the assembly with the motor, it is inevitable that the thickness of the product will be uneven during the structural design. The forming problems due to the shrinkage of the plastic material with uneven thickness will cause the reflective surface to fail to meet the optical reflective surface requirements.

Due to the high requirements for optical reflective surface of the rotating prism and the angles between the optical reflective surfaces, and the insufficient plasticity of the glass material, the cost of processing the optical surface of the reflecting mirror with metal materials or glass materials remains high, and thus the mass production is not desirable.

### SUMMARY

An objective of the present invention is to provide a LiDAR multifaceted rotating prism in order to overcome the shortcomings in the prior art.

In order to achieve the above objective, the present invention adopts the following technical solutions. A LiDAR multifaceted rotating prism comprises:
an inner core;
a cladding layer connected to the outer surface of the inner core, wherein the cladding layer is a polygonal prism rotationally symmetric about the central axis of the inner core; and
an optical film coated on the outer surface of the cladding layer.

As a further description of the above technical solution, the material of the inner core is metal, plastic, ceramic or glass.

As a further description of the above technical solution, the material of the cladding layer is optical plastic.

As a further description of the above technical solution, the normal plane of the polygonal prism outside the cladding layer is provided at a certain angle with the central axis of the inner core.

As a further description of the above technical solution, the cladding layer is provided to have multiple thicknesses.

As a further description of the above technical solution, the cladding layer is wrapped around the outside of the inner core.

As a further description of the above technical solution, the inner core and the cladding layer are integrally formed by injection molding.

As a further description of the above technical solution, the inner core and the cladding layer are two separate structures.

As a further description of the above technical solution, the internal structure of the inner core is provided to have multiple configurations.

As a further description of the above technical solution, the normal plane of each group of prisms outside the single cladding layer is provided to have multiple groups of angles with the central axis of the inner core.

The present invention provides the following beneficial effects.

According to the present invention, the inner core and the cladding layer can be made of different materials or the same material, and the structure of the inner core and the thickness of the cladding layer can be designed and manufactured according to different requirements. The material of the inner core can be selected from metal, plastic, ceramic and glass, so that the inner core has good machinability and adaptability and can be assembled with a variety of other components. The material of the cladding layer is optical plastic, which has good stability, high precision between optical surfaces, simple processing and low cost, so as to achieve high mass production. In addition, the material and the thickness of the cladding layer can be selected according to different requirements, so that the cladding layer has stable surface shape and good optical performance and can realize the functions of the rotating prism without surface shape changes or thermal deformation of the rotating prism during rotation.

### BRIEF DESCRIPTION OF THE DRAWINGS

FIG. 1 is a schematic diagram of a LiDAR multifaceted rotating prism according to the present invention with the inner core and the cladding layer being integrated;

FIG. 2 is a schematic diagram of a LiDAR multifaceted rotating prism according to the present invention with the inner core and the cladding layer being provided with a certain angle; and

FIG. 3 is a schematic diagram of a LiDAR multifaceted rotating prism according to the present invention with the inner core and the cladding layer being separated.

### LIST OF REFERENCE NUMERALS

1. inner core; 2. cladding layer; and 3. optical film.

### DETAILED DESCRIPTION OF EMBODIMENTS

The technical solutions in the embodiments of the present invention will be clearly and completely described below with reference to the drawings in the embodiments of the present invention. Obviously, the described embodiments are only some of, but not all, the embodiments of the present invention. All other embodiments obtained by those ordinary skilled in the art based on the embodiments of the present invention without any creative effort shall fall within the scope of protection of the present invention.

It should be noted that, in the description of the present invention, the orientation or the relative position indicated by the terms “center”, “upper”, “lower”, “left”, “right”, “vertical” “horizontal”, “inner”, “outer”, etc. are based on the orientation or the relative position shown in the accompanying drawings, which is for ease of describing the present invention and simplifying the description only, rather than indicating or implying that the device or the element referred to must have a particular orientation or be constructed and operated in a particular orientation, and thus cannot be interpreted as limiting the present invention. The terms “first”, “second” and “third” are merely for the illustrative purpose and should not be construed as indicating or implying the relative importance. In addition, unless otherwise explicitly defined and limited, the terms “mounting”, “connecting” and “connection” should be appreciated in a broad sense, and for example, may be interpreted as fixed connection, detachable connection or integrated connection; may be interpreted as mechanical connection or electrical connection; may be interpreted as direct connection or indirect connection via an intermediate medium; may be interpreted as internal interconnection of two elements. For those ordinary skilled in the art, the specific meaning of the above terms in the present invention should be construed according to specific circumstances.

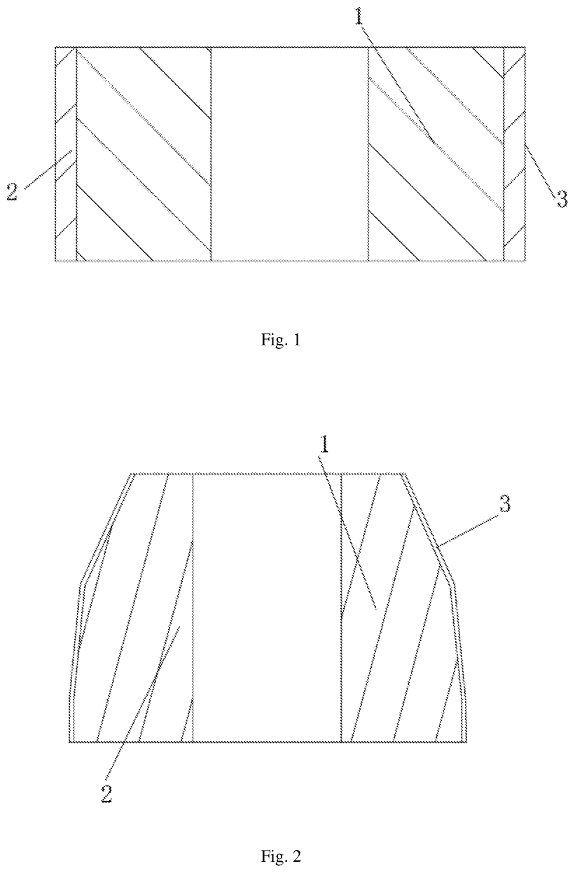

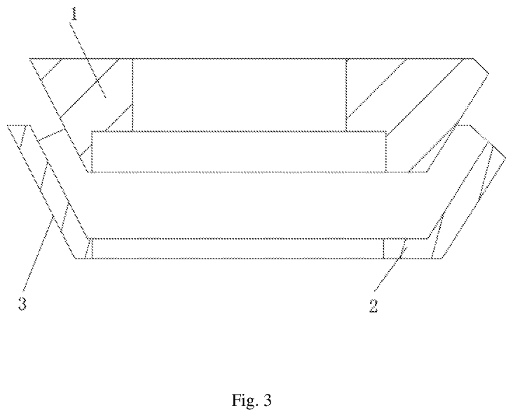

Referring to FIGS. 1-3, the present invention provides an embodiment: a LiDAR multifaceted rotating prism comprising an inner core 1;
a cladding layer 2 connected to the outer surface of the inner core 1, wherein the cladding layer 2 is a polygonal prism rotationally symmetric about the central axis of the inner core 1; and
an optical film 3 coated on the outer surface of the cladding layer 2.

The inner core 1 and the cladding layer 2 can be made of different materials or the same material, and the structure of the inner core 1 and the thickness of the cladding layer 2 can be designed and manufactured according to different requirements. The material of the inner core 1 can be selected from metal, plastic, ceramic and glass, so that the inner core 1 has good machinability and adaptability and can be assembled with a variety of other components. The material of the cladding layer 2 is optical plastic, which has good stability, high precision between optical surfaces, simple processing and low cost, so as to achieve high mass production. In addition, the material and the thickness of the cladding layer 2 can be selected according to different requirements, so that the cladding layer 2 has stable surface shape and good optical performance and can realize the functions of the rotating prism without surface shape changes or thermal deformation of the rotating prism during rotation.

Further, the material of the inner core 1 is metal, plastic, ceramic or glass.

Further, the material of the cladding layer 2 is optical plastic which is relatively stable and does not have the problems of surface shape change and thermal deformation.

Further, the normal plane of the polygonal prism outside the cladding layer 2 is provided at a certain angle with the central axis of the inner core 1, which can be different according to requirements, so that it is suitable for different environments and realizes different functions.

Further, the cladding layer 2 is provided to have multiple thicknesses, which can be different according to specific requirements.

Further, the cladding layer 2 is wrapped around the outside of the inner core 1, and the cladding layer 2 can completely or partially wrap the inner core 1 according to actual needs.

Further, the inner core 1 and the cladding layer 2 are integrally formed by injection molding.

Further, the inner core 1 and the cladding layer 2 are two separate structures.

According to the above solutions, it is possible to use an integral molding structure or two separate structures to be assembled and fixed together.

Further, the internal structure of the inner core 1 could have multiple configurations, which can be designed according to the assembly with other components.

Further, the normal plane of each group of prisms outside the single cladding layer 2 is provided to have multiple groups of angles with the central axis of the inner core 1.

In the working principle, when the device is in use, the inner core 1 and the cladding layer 2 can be made of different materials or the same material, and the structure of the inner core 1 and the thickness of the cladding layer 2 can be designed and manufactured according to different requirements. The material of the inner core 1 can be selected from metal, plastic, ceramic and glass, so that the inner core 1 has good machinability and adaptability and can be assembled with a variety of other components. The material of the cladding layer 2 is optical plastic, which has good stability, high precision between optical surfaces, simple processing and low cost, so as to achieve high mass production. In addition, the material and the thickness of the cladding layer 2 can be selected according to different requirements, so that the cladding layer 2 has stable surface shape and good optical performance and can realize the functions of the rotating prism without surface shape changes or thermal deformation of the rotating prism during rotation.

Finally, it should be noted that the foregoing description is merely the preferred embodiments of the present invention and is not intended to limit the present invention. Although the present invention has been illustrated in detail with reference to the foregoing embodiments, those ordinary skilled in the art can still modify the technical solution specified in the foregoing embodiment or make equivalent substitutions for some of the technical features thereof. Any modifications, equivalent substitutions, improvements, etc. made within the spirit and principles of the present invention shall fall within the scope of protection of the present invention.

1. A multifaceted rotating prism, comprising:
an inner core;
a cladding layer connected to an outer surface of the inner core, wherein the cladding layer is a polygonal prism rotationally symmetric about the central axis of the inner core; and
an optical film coated on the outer surface of the cladding layer.

2. The multifaceted rotating prism according to claim 1, wherein a material of the inner core is metal, plastic, ceramic, or glass.

3. The multifaceted rotating prism according to claim 1, wherein a material of the cladding layer is optical plastic.

4. The multifaceted rotating prism according to claim 1, wherein the normal plane of the polygonal prism outside the cladding layer is provided at a certain angle with the central axis of the inner core.

5. The multifaceted rotating prism according to claim 1, wherein the cladding layer is provided to have multiple thicknesses.

6. The multifaceted rotating prism according to claim 1, wherein the cladding layer is wrapped around the outside of the inner core.

7. The multifaceted rotating prism according to claim 1, wherein the inner core and the cladding layer are integrally formed by injection molding.

8. The multifaceted rotating prism according to claim 1, wherein the inner core and the cladding layer are two separate structures.

9. The multifaceted rotating prism according to claim 1, wherein the internal structure of the inner core is provided to have multiple configurations.

10. The multifaceted rotating prism according to claim 1, wherein the normal plane of each group of prisms outside the cladding layer is provided to have multiple groups of angles with the central axis of the inner core.
